(19) United States
(12) Patent Application Publication
(10) Pub. No.: US 2025/0102802 A1
(43) Pub. Date: Mar. 27, 2025

(54) GRATING BYPASS FOR MULTIPLE INCOUPLER WAVEGUIDE

(71) Applicant: GOOGLE LLC, Mountain View, CA (US)

(72) Inventors: Daniel Adema, Kitchener (CA); Timothy Paul Bodiya, Toronto (CA)

(21) Appl. No.: 18/728,294

(22) PCT Filed: Jul. 19, 2022
(86) PCT No.: PCT/US2022/037627

§ 371 Date: Jul. 11, 2024

Related U.S. Application Data
(60) Provisional application No. 63/298,318, filed on Jan. 11, 2022.

(51) Int. Cl. G02B 27/01; G02B 27/28

(52) U.S. Cl. CPC G02B 27/0172; G02B 27/283

(57) ABSTRACT

The present disclosure describes techniques and waveguides for efficiently incoupling light of different optical characteristics at multiple incouplers in a waveguide. The waveguide includes a first incoupler to incouple light with a first optical characteristic, a second incoupler to incouple light with a second optical characteristic, and a first structure at an interface of the second incoupler to reflect light with the first optical characteristic within the waveguide.

### BACKGROUND

In a conventional wearable heads-up display (WHUD), light from an image source is coupled into a light guide substrate, generally referred to as a waveguide, by an input optical coupling such as an in-coupling diffraction grating (i.e., an “incoupler”), which can be formed on a surface of the substrate or buried within the substrate. Once the light beams have been coupled into the waveguide, the light beams are “guided” through the substrate, typically by multiple instances of total internal reflection (TIR) to then be directed out of the waveguide by an output optical coupling (i.e., an “outcoupler”), which can also take the form of a diffractive optic. The light beams ejected from the waveguide overlap at an eye relief distance from the waveguide forming an exit pupil within which a virtual image generated by the image source can be viewed.

### SUMMARY

The present disclosure describes embodiments for efficiently incoupling light of different optical characteristics at multiple incouplers in a waveguide while also conforming to the space-constrained form factors in WHUDs.

In one example embodiment, a waveguide includes a first incoupler to incouple light with a first optical characteristic, a second incoupler to incouple light with a second optical characteristic, and a first structure at an interface of the second incoupler to reflect incoupled light with the first optical characteristic within the waveguide.

In some embodiments, for the waveguide, the first optical characteristic includes a first wavelength range, and the second optical characteristic includes a second wavelength range different from the first wavelength range. The first structure, for example, includes a dichroic mirror. In some embodiments, the dichroic mirror includes a shortpass dichroic mirror with a cutoff wavelength between the first wavelength range and the second wavelength range.

In other embodiments, for the waveguide, wherein the first optical characteristic includes a first polarization state, and the second optical characteristic includes a second polarization state different from the first polarization state. The first structure, for example, includes a polarization beam splitter. The polarization beam splitter reflects light of the first polarization state and transmits light of the second polarization state, for example.

In other embodiments, for the waveguide, the first optical characteristic includes a first angle of light incoupled into the waveguide at the first incoupler grating and the second optical characteristic includes a second angle of light incoupled into the waveguide at the second incoupler grating, wherein the second angle is different from the first angle. The first structure, for example, includes a lower-refractive index material than a material of a waveguide substrate of the waveguide.

In some embodiments, for the waveguide, the second incoupler is arranged subsequent to the first incoupler in a direction of light propagation toward one or more outcouplers of the waveguide.

In further embodiments, the waveguide further includes a third incoupler to incouple light of a third optical characteristic, and a second structure at an interface of the third incoupler to reflect incoupled light with the first optical characteristic and incoupled light with the second optical characteristic within the waveguide. In some embodiments, the first optical characteristic includes a first wavelength range, the second optical characteristic includes a second wavelength range different from the first wavelength range, and the third optical characteristic includes a third wavelength range different from the first wavelength range and the second wavelength range. For example, in these embodiments, the first structure includes a first dichroic mirror, and the second structure includes a second dichroic mirror. Furthermore, the first dichroic mirror includes a shortpass dichroic mirror with a cutoff wavelength between the first wavelength range and the second light wavelength range, and the second dichroic mirror includes a second shortpass dichroic mirror with a cutoff wavelength between the third wavelength range and the first and second wavelength ranges. In some embodiments, the third incoupler is arranged subsequent to the first incoupler and the second incoupler in a direction of light propagation toward one or more outcouplers of the waveguide.

In another example embodiment, a method includes incoupling, via a first incoupler, light with a first optical characteristic into a waveguide; incoupling, via a second incoupler, light with a second optical characteristic into the waveguide; and reflecting, by a first structure at an interface between the second incoupler and a waveguide substrate of the waveguide, incoupled light with the first optical characteristic within the waveguide.

In some embodiments, the method includes that the first optical characteristic includes a first wavelength range, and the second optical characteristic includes a second wavelength range different from the first wavelength range. Additionally, in some embodiments, the first structure includes a first dichroic mirror with a cutoff wavelength between the first wavelength range and the second wavelength range.

In some embodiments, the method includes incoupling, via a third incoupler, light with a third optical characteristic into the waveguide; and reflecting, via a second structure at an interface between the third incoupler and the waveguide substrate of the waveguide, incoupled light with the first optical characteristic and incoupled light with the second optical characteristic within the waveguide. In some embodiments, the method includes that the third optical characteristic includes a third wavelength range different from the first wavelength range and the second wavelength range, and the second structure includes a second dichroic mirror with a cutoff wavelength between the third wavelength range and the first and second wavelength ranges.

In some embodiments, the method includes that the first optical characteristic includes a first polarization state, and the second optical characteristic includes a second polarization state different from the first polarization state, and wherein the first structure includes a polarization beam splitter.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system having a support structure that houses a projection system configured to project images toward the eye of a user, in accordance with some embodiments.

FIG. 2 shows an example of a block diagram of a projection system that projects light representing images onto the eye of a user via a display system, such as the display system of FIG. 1, in accordance with some embodiments.

FIG. 3 shows an example of light propagation within a waveguide of a projection system, such as the projection system of FIG. 2, in accordance with some embodiments.

FIG. 4 shows an example of separate incoupler gratings that are in line with one another in a direction of light propagation, in accordance with some embodiments.

FIG. 5 shows an example of light being outcoupled of a waveguide, in accordance with some embodiments.

FIG. 6 shows an example of a waveguide with a dichroic mirror being placed at an interface of a second incoupler grating and the waveguide substrate, in accordance with some embodiments.

FIG. 7 shows an example of a waveguide with a dichroic mirror being placed at an interface of a second incoupler grating and the waveguide substrate and at an interface of a third incoupler grating and the waveguide substrate, in accordance with some embodiments.

FIG. 8 shows an alternative view of FIG. 8, in accordance with some embodiments.

FIG. 9 shows an example of a waveguide with a polarization beam splitter placed at an interface of a second incoupler grating and the waveguide substrate, in accordance with some embodiments.

FIG. 10 shows an example of a waveguide with a lower refractive index material placed at an interface of a second incoupler grating and the waveguide substrate, in accordance with some embodiments.

FIG. 11 shows an example of a flowchart describing a method to incouple light into a waveguide, in accordance with some embodiments.

### DETAILED DESCRIPTION

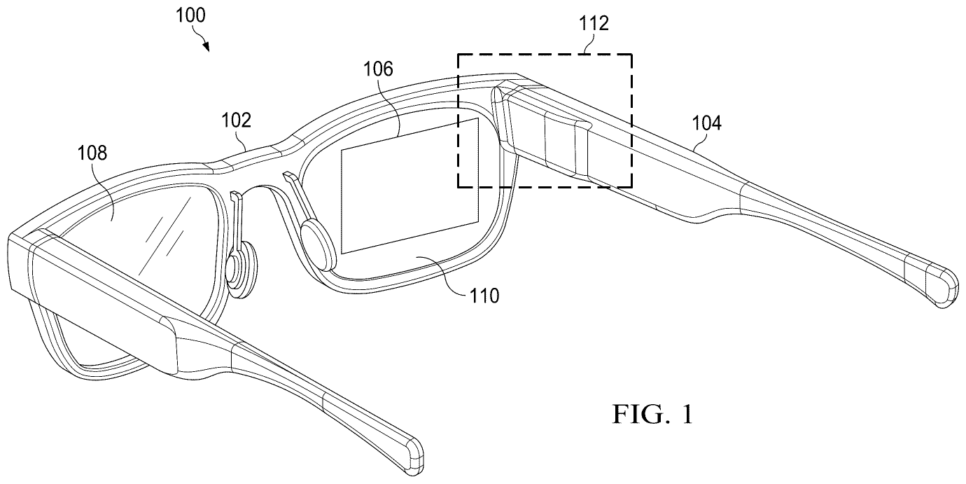

Inefficient transmission of received light through a waveguide of a WHUD can result in poor image quality at a user's eye and generally be detrimental to the user experience. For example, sources of inefficiency at the incoupler are the differing coupling efficiencies for an input light's different optical characteristics (e.g., wavelengths/colors or polarization states) and co-linear red+green+blue (RGB) light being incoupled into the waveguide and propagated as angularly separated light. FIGS. 1-11 illustrate techniques for increasing the efficiency of light propagation within a waveguide while also conforming to the space-constrained form factors in WHUDs. This, in turn, improves the quality of the image provided to the user.

To illustrate, the present disclosure includes a waveguide with multiple incouplers with each incoupler having a grating that is tuned to incouple light into a waveguide with one of a plurality of different optical characteristics (e.g., wavelength ranges/colors or polarization states). In some cases, the multiple incouplers are arranged one after one another (i.e., subsequent to each other) in a direction of light propagation to occupy less space and better conform to the space-constrained form factors in WHUDs. However, in such an arrangement, light incoupled at one incoupler may be reflected by the waveguide such that at least a portion of the light is lost (e.g., outcoupled) at a different incoupler. Using the techniques described herein, this premature outcoupling of light is prevented by placing selectively reflective structures at one or more the incouplers to reflect light having a specific optical characteristic, such as a specified color or polarization state.

For example, in some embodiments a waveguide includes two incouplers. The first incoupler is a grating configured to incouple red light, and the second incoupler is a grating configured to incouple blue+green light. The second incoupler is located, relative to the first incoupler, in a direction between the first incoupler and the corresponding outcouplers for the first and second incoupler. This configuration results in the red incoupled light from the first incoupler potentially interacting with second incoupler as the red incoupled light propagates through the waveguide. Using the techniques described herein, a dichroic mirror with a cutoff wavelength value between the red light range and the blue+green light range is placed at or near the second incoupler. Accordingly, the dichroic mirror reflects the red light and passes the blue+green light. This prevents (or reduces) the loss of red light at the second incoupler, thereby improving the overall quality of the image provided by the waveguide.

FIGS. 1-11 illustrate embodiments of an example display system and techniques to increase the amount of incoupled light propagated within a waveguide to an outcoupler, as described in greater detail below. However, it will be appreciated that the apparatuses and techniques of the present disclosure are not limited to implementation in this particular display system, but instead may be implemented in any of a variety of display systems using the guidelines provided herein.

FIG. 1 illustrates an example display system 100 having a support structure 102 that includes an arm 104, which houses a laser projection system configured to project images toward the eye of a user, such that the user perceives the projected images as being displayed in a field of view (FOV) area 106 of a display at one or both of lens elements 108, 110. In the depicted embodiment, the display system 100 is a wearable heads-up display (WHUD) that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a laser projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, laser light used to form a perceptible image or series of images may be projected by a laser projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. In some embodiments, the waveguide includes multiple incouplers with each incoupler being tuned to incouple light of one of a plurality of optical characteristics into the waveguide to increase the amount of light displayed to the user in the FOV area 106. The multiple incouplers, in some embodiments, are arranged subsequent to one another along a path of light propagation in the direction of one or more corresponding outcouplers to fall within space-form factors of display system 100. Furthermore, in some embodiments, one or more of the incouplers includes a selectively reflective structure to reflect light incoupled at one or more other incouplers so that this light is not prematurely outcoupled before being displayed to the user in the FOV area 106. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a digital light processing-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, an optical relay disposed between the first and second scan mirrors, and a waveguide disposed at the output of the second scan mirror. In some embodiments, at least a portion of an outcoupler of the waveguide may overlap the FOV area 106. These aspects are described in greater detail below.

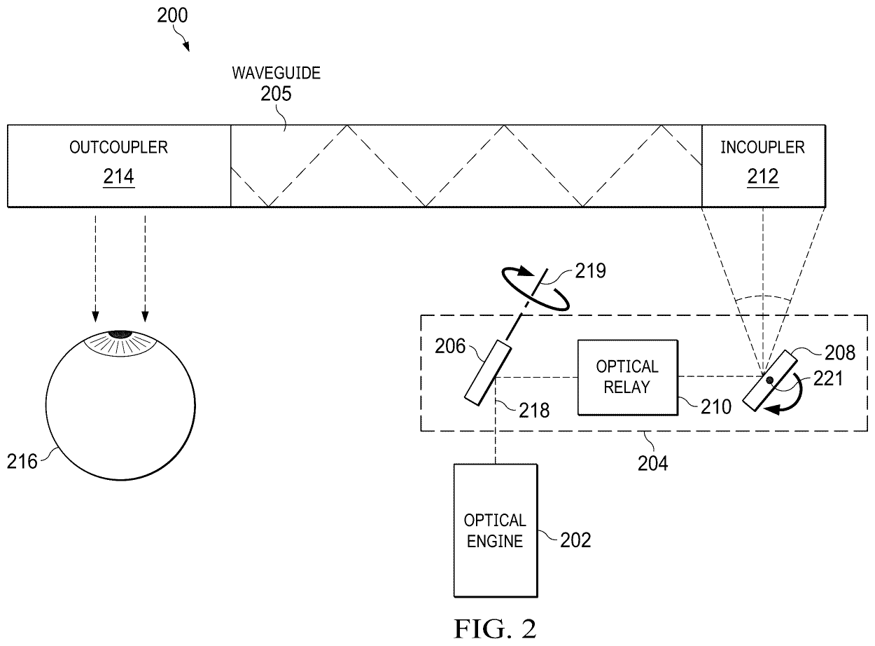

FIG. 2 illustrates a simplified block diagram of a projection system 200 that projects images directly onto the eye of a user via light. The projection system 200 includes an optical engine 202, an optical scanner 204, and a waveguide 205. The optical scanner 204 includes a first scan mirror 206, a second scan mirror 208, and an optical relay 210. The waveguide 205 includes an incoupler 212 and an outcoupler 214, with the outcoupler 214 being optically aligned with an eye 216 of a user in the present example. In some embodiments, the projection system 200 is implemented in a wearable heads-up display or other display system, such as the display system 100 of FIG. 1.

The optical engine 202 includes one or more light sources configured to generate and output light 218 (e.g., visible light such as red, blue, and green light and/or non-visible light such as infrared light). In some embodiments, the optical engine 202 is coupled to a driver or other controller (not shown), which controls the timing of emission of light from the light sources of the optical engine 202 in accordance with instructions received by the controller or driver from a computer processor coupled thereto to modulate the light 218 to be perceived as images when output to the retina of an eye 216 of a user.

For example, during the operation of the projection system 200, multiple light beams having respectively different wavelengths are output by the light sources of the optical engine 202, then combined via a beam combiner (not shown), before being directed to the eye 216 of the user. The optical engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

One or both of the scan mirrors 206 and 208 of the optical scanner 204 are MEMS mirrors in some embodiments. For example, the scan mirror 206 and the scan mirror 208 are MEMS mirrors that are driven by respective actuation voltages to oscillate during active operation of the projection system 200, causing the scan mirrors 206 and 208 to scan the light 218. Oscillation of the scan mirror 206 causes light 218 output by the optical engine 202 to be scanned through the optical relay 210 and across a surface of the second scan mirror 208. The second scan mirror 208 scans the light 218 received from the scan mirror 206 toward an incoupler 212 of the waveguide 205. In some embodiments, the light directed towards the incoupler 212 of the waveguide 205 from the scan mirror 208 is separated into light of different optical characteristics. That is, multiple inputs of light are directed to incoupler 212, with each input of light having one of a plurality of optical characteristics (e.g., wavelength ranges/colors) associated with it. In some embodiments, the scan mirror 206 oscillates along a first scanning axis 219, such that the light 218 is scanned in only one dimension (i.e., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 212 has a substantially rectangular profile and is configured to receive the light 218 and direct the light 218 into the waveguide 205. The incoupler 212 is defined by a smaller dimension (i.e., width) and a larger orthogonal dimension (i.e., length). In an embodiment, the optical relay 210 is a line-scan optical relay that receives the light 218 scanned in a first dimension by the first scan mirror 206 (e.g., the first dimension corresponding to the small dimension of the incoupler 212), routes the light 218 to the second scan mirror 208, and introduces a convergence to the light 218 in the first dimension to an exit pupil beyond the second scan mirror 208. Herein, an “exit pupil” in an optical system refers to the location along the optical path where beams of light intersect. For example, the possible optical paths of the light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the light corresponding to that exit pupil. Accordingly, the exit pupil can be considered a “virtual aperture.” According to various embodiments, the optical relay 210 includes one or more collimation lenses that shape and focus the light 218 on the second scan mirror 208 or includes a molded reflective relay that includes two or more spherical, aspheric, parabolic, and/or freeform lenses that shape and direct the light 218 onto the second scan mirror 208. The second scan mirror 208 receives the light 218 and scans the light 218 in a second dimension, the second dimension corresponding to the long dimension of the incoupler 212 of the waveguide 205. In some embodiments, the second scan mirror 208 causes the exit pupil of the light 218 to be swept along a line along the second dimension. In some embodiments, the incoupler 212 is positioned at or near the swept line downstream from the second scan mirror 208 such that the second scan mirror 208 scans the light 218 as a line or row over the incoupler 212.

In some embodiments, the optical engine 202 includes an edge-emitting laser (EEL) that emits a laser light 218 having a substantially elliptical, non-circular cross-section, and the optical relay 210 magnifies or minimizes the laser light 218 along its semi-major or semi-minor axis to circularize the laser light 218 prior to convergence of the laser light 218 on the second scan mirror 208. In some such embodiments, a surface of a mirror plate of the scan mirror 206 is elliptical and non-circular (e.g., similar in shape and size to the cross-sectional area of the laser light 218). In other such embodiments, the surface of the mirror plate of the scan mirror 206 is circular.

The waveguide 205 of the projection system 200 includes the incoupler 212 and the outcoupler 214. The term “waveguide,” as used herein, will be understood to mean a combiner using one or more of total internal reflection (TIR), specialized filters, and/or reflective surfaces, to transfer light from an incoupler (such as the incoupler 212) to an outcoupler (such as the outcoupler 214). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the laser light 218 received at the incoupler 212 is relayed to the outcoupler 214 via the waveguide 205 using TIR. The laser light 218 is then output to the eye 216 of a user via the outcoupler 214. As described above, in some embodiments the waveguide 205 is implemented as part of an eyeglass lens, such as the lens 108 or lens 110 (FIG. 1) of the display system having an eyeglass form factor and employing the projection system 200.

In some embodiments, although only one incoupler 212 is shown in FIG. 2, the waveguide 205 includes multiple incouplers 212 to increase the amount of input light that is incoupled to the waveguide 205. Each of the incouplers is tuned to incouple light of one of a plurality of optical characteristics into the waveguide 205 so that the overall coupling efficiency of projection system 200 is increased, where the coupling efficiency is the amount of light propagated along the waveguide divided by the amount of input (also referred to as incident) light. Parameters of the incoupler grating that can be tuned include, but are not limited to, grating height, grating spacing, grating angles, and grating density. Furthermore, since each incoupler has different grating parameters, different manufacturing processes can be used. In some embodiments, the plurality of optical characteristics is a plurality of wavelength ranges. In other embodiments, the plurality of optical characteristics is a plurality of polarization states. In some cases, the multiple incouplers are arranged one after one another (i.e., subsequent to one another) in a direction of light propagation in order to occupy less space in a WHUD system. In order to prevent loss of light incoupled at previous incouplers at subsequent incouplers, reflective structures are placed at an interface with the waveguide, or integrated into, the subsequent incouplers. These structures have selected reflective qualities to prevent light that is incoupled at previous incouplers from interacting with (i.e., being outcoupled at) the subsequent incoupler, as described further herein.

The terms “incoupler” and “incoupler grating” are used to correspond with one another in this specification and the associated figures unless specifically indicated otherwise. Accordingly, discussion of a “first incoupler grating,” “second incoupler grating,” “third incoupler grating,” or the like (e.g., “first grating, “second grating, “third grating”), corresponds to a “first incoupler,” “second incoupler,” and “third incoupler,” respectively, unless indicated otherwise.

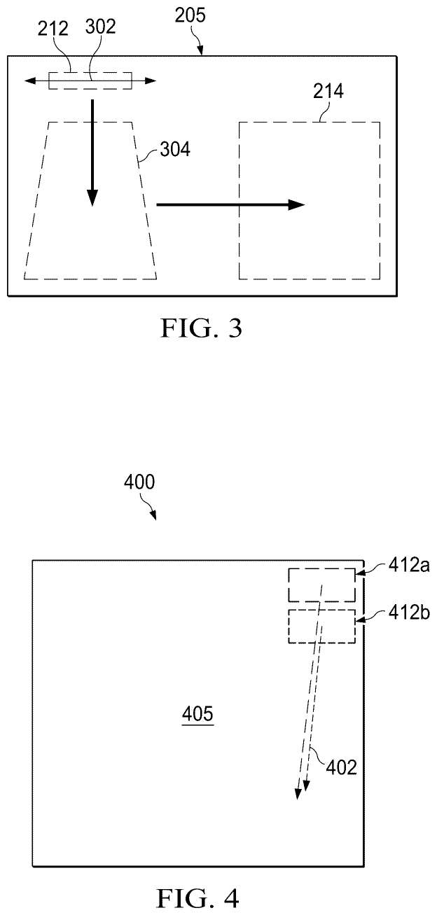

Although not shown in the example of FIG. 2, in some embodiments additional optical components are included in any of the optical paths between the optical engine 202 and the scan mirror 206, between the scan mirror 206 and the optical relay 210, between the optical relay 210 and the scan mirror 208, between the scan mirror 208 and the incoupler 212, between the incoupler 212 and the outcoupler 214, and/or between the outcoupler 214 and the eye 216 (e.g., in order to shape the laser light for viewing by the eye 216 of the user). In some embodiments, a prism is used to steer light from the scan mirror 208 into the incoupler 212 so that light is coupled into incoupler 212 at the appropriate angle to encourage propagation of the light in waveguide 205 by TIR. Also, in some embodiments, an exit pupil expander (e.g., an exit pupil expander 304 of FIG. 3, described below), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the laser light out of waveguide 205 (e.g., toward the eye 216 of the user).

FIG. 3 shows an example of light propagation within the waveguide 205 of the projection system 200 of FIG. 2 in accordance with some embodiments. As shown, light received via the incoupler 212, which is scanned along the axis 302, is directed into an exit pupil expander (EPE) 304 and is then routed to the outcoupler 214 to be output (e.g., toward the eye of the user). In some embodiments, the exit pupil expander 304 expands one or more dimensions of the eyebox of a WHUD that includes the projection system 200 (e.g., with respect to what the dimensions of the eyebox of the WHUD would be without the exit pupil expander 304). In some embodiments, the incoupler 212 and the exit pupil expander 304 each include respective one-dimensional diffraction gratings (i.e., diffraction gratings that extend along one dimension). It should be understood that FIG. 3 shows a substantially ideal case in which the incoupler 212 directs light straight down (with respect to the presently illustrated view) in a first direction that is perpendicular to the scanning axis 302, and the exit pupil expander 304 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

In some embodiments where the waveguide 205 includes multiple incouplers 212, the waveguide 205 also includes multiple corresponding exit pupil expanders 304 and/or outcouplers 214. For example, a first incoupler directs light through a first exit pupil expander to a first outcoupler, and a second incoupler directs light through a second exit pupil expander to a second outcoupler. In some embodiments, each of the incouplers and their corresponding exit pupil expanders and outcouplers are specifically tuned to propagate light of one optical characteristic of a plurality of optical characteristics through waveguide 205 to a user.

The multiple incouplers may be applied to a waveguide positioned beside one another (i.e., laterally adjacent to each other) so that the path of light incoupled by a first incoupler and the path of light incoupled by a second or subsequent incouplers do not intersect. In other words, each incoupler is not subsequent to another incoupler in the direction of light propagation toward one or more outcouplers. While this prevents the light incoupled by the multiple incouplers from directly interacting with one another, such a configuration requires a thicker substrate and more space to accommodate the waveguide, which negatively impacts other system parameters (e.g., optical uniformity and system complexity). Additionally, in highly space-constrained form factors, such as the WHUD 100 of FIG. 1, there typically is not room available to accommodate such a setup. The techniques described herein address this issue by arranging the incouplers in line with one another in a direction of light propagation. Furthermore, selectively reflective structures are placed at one or more of the incouplers to reflect light having a specified optical characteristic, such as a specified color or polarization.

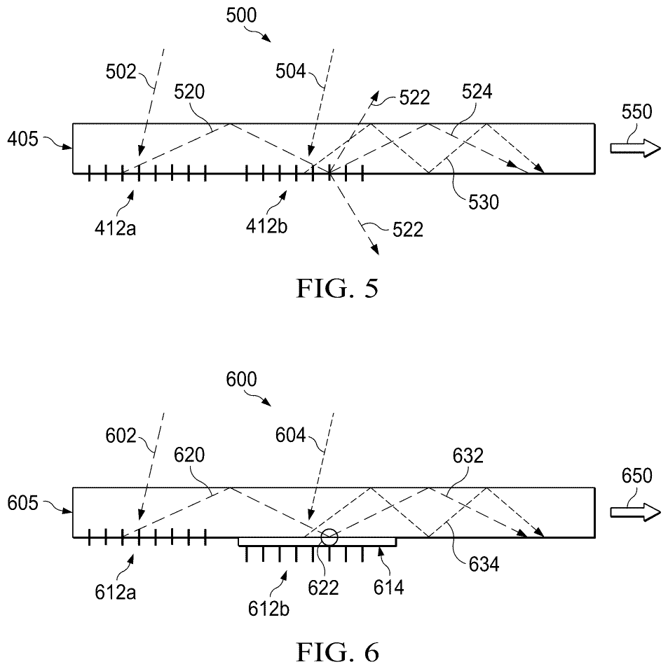

FIGS. 4 and 5 shows a side view portion 400 and a top view 500, respectively, of a portion of a waveguide substrate 405, such as one corresponding to waveguide 205 of FIG. 2. As shown, waveguide substrate 405 has multiple incouplers with first incoupler 412a and second incoupler 412b. The first incoupler 412a receives first input light 502 of a first wavelength range (e.g., corresponding to red light) and incouples this light into the waveguide 405 as first incoupler incoupled light 520. The second incoupler 412b receives second input light 504 of a second wavelength range (e.g., corresponding to blue and green light) and incouples this light into the waveguide 405 as second incoupler incoupled light 530. Each of the incouplers 412a and 412b is tuned to receive light of the corresponding wavelength range in order to increase the coupling efficiency of the waveguide. Furthermore, in order to reduce the space needed to implement a multiple incoupler setup, the second incoupler 412b is positioned subsequent to the first incoupler 412a in a direction of light propagation 402 toward one or more outcouplers 550. Because the second incoupler 412b is positioned in the path of light propagation 402 from the first incoupler 412a, a portion of the first incoupler incoupled light 520 may potentially interact with second incoupler 412b and be lost 522, i.e., be prematurely outcoupled by the second incoupler 412b. This results in a reduced amount of first incoupler incoupled light 512 in 524 propagating toward the exit pupil expander(s) and the outcouplers(s) 550. In other words, the amount of light at 524 is the first incoupler incoupled light 520 reduced by the amount of the lost light 522.

Accordingly, as described in more detail below, in some embodiments a reflective structure is placed at one or more of the incouplers to reflect light having one or more specified optical characteristics associated with another incoupler, thus preventing or reducing the amount of light lost at the incouplers and improving the quality of the image provided by the waveguide.

FIG. 6 shows a top view 600 of a portion of a waveguide substrate 605, such as one corresponding to waveguide 205 of FIG. 2, having a first incoupler 612a and a second incoupler 612b. The first incoupler 612a receives first input light 602 of a first wavelength range and incouples this light into the waveguide 605 as first incoupler incoupled light 620. The second incoupler 612b receives second input light 604 of a second wavelength range and incouples this light into the waveguide 605 as second incoupler incoupled light 634. Each of the incouplers 612a and 612b is tuned to receive light of the corresponding wavelength range in order to increase the coupling efficiency. Furthermore, in order to reduce the space needed to implement a multiple incoupler setup, the second incoupler 612b is positioned subsequent to the first incoupler 612a in a direction of light propagation toward one or more outcouplers 650 (similar to the setup shown in FIGS. 4-5).

In order to prevent outcoupling of the first incoupler incoupled light 620 at the second incoupler 612b (i.e., as shown in FIG. 5), a reflective structure 614 is placed at the second incoupler 612b. For example, as illustrated, the reflective structure 614 is at an interface of the waveguide substrate 605 and the second incoupler 612b. The reflective structure 614 is a dichroic mirror that reflects light of the first wavelength range corresponding to the first incoupler incoupled light 620 and transmits light with the second wavelength range corresponding to input light 604 and second incoupler incoupled light 634. This reflection of the first incoupler incoupled light 620 is shown at 622. In this manner, the reflective structure 614 prevents the loss of first incoupler incoupled light 620 at the second incoupler 612b. Therefore, the amount of first incoupler incoupled light 620 that propagates in 632 toward the exit pupil expander(s) and the outcouplers(s) 650 is increased. In other words, because the reflective structure 614 prevents the first incoupler incoupled light 620 from being outcoupled at 612b, the light at 632 is, or is substantially, the same as the first incoupler incoupled light 620. Thereby, the coupling efficiency is increased, resulting in an improved image quality delivered to the user.

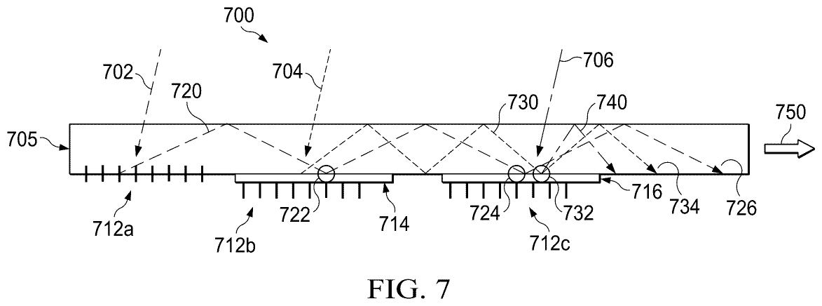

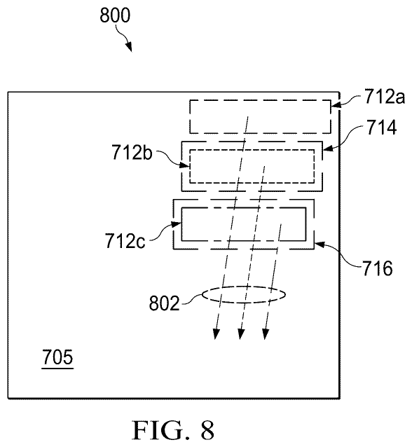

For example, in a case where the first incoupler 612a incouples first input light 602 with a first wavelength range corresponding to red light and the second incoupler 612b incouples second input light 604 with a second wavelength range corresponding to blue+green light, a dichroic mirror is used as the reflective structure 614. The dichroic mirror has a cutoff wavelength value in between red light and the green light so as to reflect red light and transmit blue+green light. In this manner, the first incoupler incoupled light 620 (red light) bypasses the second incoupler 612b by reflecting off the dichroic mirror 614 at 622. While FIG. 6 shows a waveguide having two incouplers 612a and 612b, in some embodiments, the waveguide has three or more incouplers as illustrated in FIGS. 7-8. Including more incouplers allows each incoupler to be tuned to a finer range of optical characteristics, thereby increasing the overall coupling efficiency of the system. In some embodiments, although three incouplers are shown in FIGS. 7-8, it is appreciated that the number of incouplers is scalable to other quantities (e.g., four or more) depending on system performance considerations. For example, a larger number of incouplers is utilized if higher levels of FOV multiplexing is implemented or if the incoupling of light into the waveguide is segmented for other optical and/or performance-related reasons.

FIGS. 7 and 8 shows a top view 700 and a side view 800, respectively, of a portion of a waveguide substrate 705, such as one corresponding to waveguide 205 of FIG. 2. As shown waveguide substrate 705 has a first incoupler grating 712a, a second incoupler grating 712b, and a third incoupler grating 712c. The first incoupler 712a receives first input light 702 of a first wavelength range and incouples this light into the waveguide 705 as first incoupler incoupled light 720. The second incoupler 712b receives second input light 704 of a second wavelength range and incouples this light into the waveguide 705 as second incoupler incoupled light 730. The third incoupler 712c receives third input light 706 of a third wavelength range and incouples this light into the waveguide 705 as third incoupler incoupled light 740. Each of the incouplers 712a, 712b, 712c is tuned to receive light of the corresponding wavelength range in order to increase the coupling efficiency of the waveguide. Furthermore, in order to reduce the space needed to implement a multiple incoupler setup, the second incoupler 712b is positioned subsequent to the first incoupler 712a in a direction of light propagation 802 toward one or more outcouplers, and the third incoupler 712c is positioned subsequent to the second incoupler 712b in a direction of light propagation 802 toward one or more outcouplers 750.

In order to prevent outcoupling of light incoupled at other incouplers, reflective structures 714 and 716 are placed at the second incoupler 712b and the third incoupler 712c, respectively. For example, in order to prevent outcoupling of the first incoupler incoupled light 720 at the second incoupler 712b, a reflective structure 714 is placed at the second incoupler 712b. And, in order to prevent outcoupling of the first incoupler incoupled light 720 and the second incoupler incoupled light 730 at the third incoupler 712c, a reflective structure 716 is placed at the third incoupler 712c. As illustrated, each of the reflective structures 714, 716 are at an interface of the waveguide substrate 705 and the respective incoupler 712b, 712c. The reflective structure 714 is a dichroic mirror that reflects light of the first wavelength range corresponding to the first incoupler incoupled light 720 and transmits light of the second wavelength range corresponding to second input light 704 and second incoupler incoupled light 730. In other words, the dichroic mirror at 714 has a cutoff wavelength value between the first wavelength range and the second wavelength range. The reflective structure 716 is a dichroic mirror that reflects light of the first wavelength range corresponding to the first incoupler incoupled light 720 and light of the second wavelength range corresponding to the second incoupler incoupled light 730 and transmits light of the third wavelength range corresponding to third input light 706 and third incoupler incoupled light 740. In other words, the dichroic mirror at 716 has a cutoff wavelength value between the third wavelength range and the first and second wavelength ranges. Accordingly, the light incoupled by the incouplers is able to bypass the other incouplers by reflecting off the dichroic mirrors.

The reflection of the first incoupler incoupled light 720 at the second incoupler 712b is shown at 722. In this manner, the reflective structure 714 prevents the loss of first incoupler incoupled light 720 at the second incoupler 712b. Similarly, the reflective structure 716 reflects the first incoupler incoupled light 720 at 724 and also reflects the second incoupler incoupled light 730 at 732. In this manner, the reflective structure 716 prevents the loss of first incoupler incoupled light 720 and the second incoupler incoupled light 730 at the third incoupler 712c. Therefore, the amount of first incoupler incoupled light 720 and the amount of second incoupler incoupled light 730 that propagates in 726 and 734, respectively, is increased. This results in an improved image quality delivered to the user.

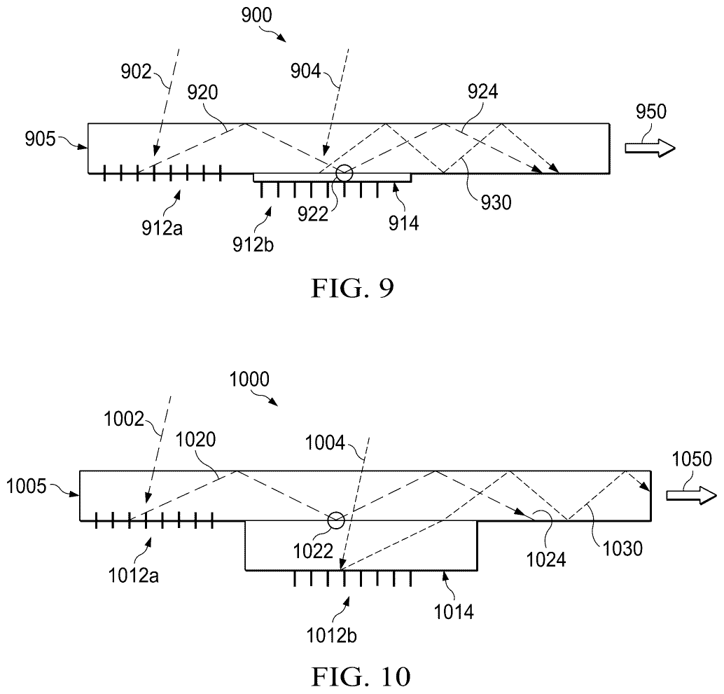

Furthermore, although FIGS. 4-8 are discussed with respect to the incouplers being tuned to incouple light into the waveguide with different wavelength ranges, it will be appreciated that in other embodiments the incouplers are tuned to incouple light into a waveguide with different polarization states or other optical characteristics. Examples of these other embodiments are discussed in further detail below in FIGS. 9 and 10.

FIG. 9 shows a top view 900 of a portion of a waveguide substrate 905, such as one corresponding to waveguide 205 of FIG. 2, having a first incoupler 612a and a second incoupler 912b. The first incoupler 912a receives first input light 902 having a first polarization state and incouples this light into the waveguide 905 as first incoupler incoupled light 920. The second incoupler 912b receives second input light 904 having a second polarization state and incouples this light into the waveguide 905 as second incoupler incoupled light 930. In some embodiments, using polarization techniques for the incoupling of light allows multiple light sources of the same color to be used, for example. Each of the incouplers 912a and 912b is tuned to receive light of the specific polarization state in order to increase the coupling efficiency of the waveguide. For example, the first polarization state is S-polarization, and the second polarization state is P-polarization, or vice versa. Furthermore, in order to reduce the space needed to implement a multiple incoupler setup, the second incoupler 912b is positioned subsequent to the first incoupler 912a in a direction of light propagation toward one or more outcouplers 950.

In order to prevent outcoupling of the first incoupler incoupled light 920 at the second incoupler 912b, a PBS layer 914 is placed at the second incoupler 912b. For example, as illustrated, the PBS layer 914 is at an interface of the waveguide substrate 905 and the second incoupler 912b. The PBS layer 914 reflects light with the first polarization state corresponding to the first incoupler incoupled light 920 and transmits light with the second polarization state corresponding to input light 904 and second incoupler incoupled light 930. The reflection of the first incoupler incoupled light 920 is shown at 922. Accordingly, the PBS layer 914 prevents the premature outcoupling of first incoupler incoupled light 920 at the second incoupler 912b. Therefore, the amount of first incoupler incoupled light 920 that propagates in 924 toward the exit pupil expander(s) and the outcouplers(s) 950 is increased, resulting in an improved image quality delivered to the user.

FIG. 10 shows a top view 1000 of a portion of a waveguide substrate 1005, such as one corresponding to waveguide 205 of FIG. 2, having a first incoupler 1012a and a second incoupler 1012b. The first incoupler 1012a receives first input light 1002 and incouples this light into the waveguide 1005 as first incoupler incoupled light 1020 with a first incoupled angle. The second incoupler 1012b receives second input light 1004 and incouples this light into the waveguide 1005 as second incoupler incoupled light 1030 with a second incoupled angle. Each of the incouplers 1012a and 1012b are tuned to incouple light into the waveguide at the respective angles. In order to reduce the space needed to implement a multiple incoupler setup, the second incoupler 1012b is positioned subsequent to the first incoupler 1012a in a direction of light propagation toward one or more outcouplers 1050.

In order to prevent outcoupling of the first incoupler incoupled light 1020 at the second incoupler 1012b, a lower-refractive index layer 1014 is placed at the second incoupler 1012b. For example, as illustrated, the lower-refractive index layer 1014 is at an interface of the waveguide substrate 1005 and the second incoupler 1012b. The lower-refractive index layer 1014 reflects the first incoupler incoupled light 1020 and transmits the input light 1004 and the second incoupler incoupled light 1030. Because the angle of the first incoupler incoupled light 1020 is steeper than the input light 1004, the first incoupler incoupled light 1020 is within the range of critical angles to be bounded by total internal reflection (TIR) and is thus reflected from the boundary created at the lower-refractive index material 1114 and the waveguide substrate 1105. For example, the index of refraction of the waveguide substrate is n=2.0 and the index of refraction for the lower-refractive index material 1014 is n=1.4. It is appreciated that these values are examples and, generally speaking, the material of the lower-refractive index material 1014 is selected based on its refractive index being lower than that of the waveguide substrate 1005. The reflection of the first incoupler incoupled light 1020 is shown at 1022. In this manner, the lower-refractive index layer 1014 prevents the loss of first incoupler incoupled light 1020 at the second incoupler 1012b. Therefore, the amount of first incoupler incoupled light 1020 that propagates in 1024 toward the exit pupil expander(s) and the outcouplers(s) 1050 is increased, resulting in an improved image quality delivered to the user.

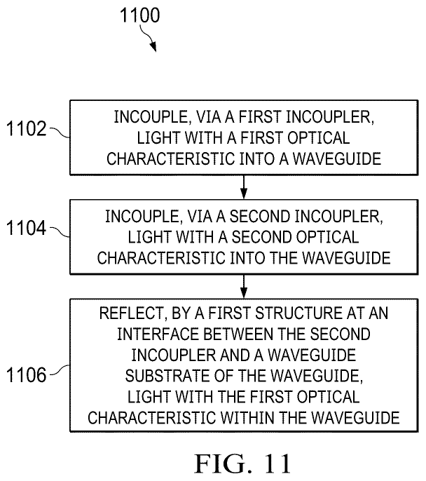

FIG. 11 shows a method flowchart 1100 for incoupling light with different optical characteristics into a waveguide, in accordance with some embodiments. The method includes to, in 1102, incouple, via a first incoupler, light with a first optical characteristic into a waveguide. The method includes to, in 1104, incouple, via a second incoupler, light with a second optical characteristic into the waveguide. The method includes to, in 1106, reflect, by a first structure at an interface between the second incoupler and a waveguide substrate of the waveguide, light with the first optical characteristic within the waveguide.

In some embodiments, the method further includes to incouple, via a third incoupler, light with a third optical characteristic into the waveguide. In some embodiments, the method further includes to reflect, via a second structure at an interface between the third incoupler and the waveguide substrate of the waveguide, incoupled light with the first optical characteristic and incoupled light with the second optical characteristic.

In some embodiments, the first, second, and, if applicable, third optical characteristics of the method are wavelength ranges. In other embodiments, the optical characteristics are polarization states or angles of light incoupled into the waveguide.

The reflective structures described in the present disclosure reflect light that is inside the waveguide. For example, the reflective structure at a second incoupler in a multiple incoupler waveguide reflects light that is incoupled into the waveguide by the first incoupler. In other words, the reflective structure reflects already-incoupled light so that it is retained for propagation within the waveguide.

Referring to FIGS. 1-11 the direction of incident light, grating features, and propagated light are depicted in the plane of the page for clarity. However, the direction of some or all of the light paths and/or features may be in or out of the plane of the page. Further, the techniques and systems described above are applicable to linescan MEMS relay system, as well as to 2-D optical relay systems.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide comprising:
a first incoupler to incouple light with a first optical characteristic;
a second incoupler to incouple light with a second optical characteristic; and
a first structure at an interface of the second incoupler to reflect incoupled light with the first optical characteristic within the waveguide.

2. The waveguide of claim 1, wherein the first optical characteristic comprises a first wavelength range, and the second optical characteristic comprises a second wavelength range different from the first wavelength range.

3. The waveguide of claim 2, wherein the first structure comprises a dichroic mirror.

4. The waveguide of claim 3, wherein the dichroic mirror comprises a shortpass dichroic mirror with a cutoff wavelength between the first wavelength range and the second wavelength range.

5. The waveguide of claim 1, wherein the first optical characteristic comprises a first polarization state, and the second optical characteristic comprises a second polarization state different from the first polarization state.

6. The waveguide of claim 5, wherein the first structure comprises a polarization beam splitter.

7. The waveguide of claim 6, wherein the polarization beam splitter reflects light of the first polarization state and transmits light of the second polarization state.

8. The waveguide of claim 1, wherein the first optical characteristic comprises a first angle of light incoupled into the waveguide at the first incoupler grating and the second optical characteristic comprises a second angle of light incoupled into the waveguide at the second incoupler grating, wherein the second angle is different from the first angle.

9. The waveguide of claim 8, wherein the first structure comprises a lower-refractive index material than a material of a waveguide substrate of the waveguide.

10. The waveguide of claim 1, wherein the second incoupler is arranged subsequent to the first incoupler in a direction of light propagation toward one or more outcouplers of the waveguide.

11. The waveguide of claim 1, further comprising:
a third incoupler to incouple light of a third optical characteristic; and
a second structure at an interface of the third incoupler to reflect incoupled light with the first optical characteristic and incoupled light with the second optical characteristic within the waveguide.

12. The waveguide of claim 11, wherein the first optical characteristic comprises a first wavelength range, the second optical characteristic comprises a second wavelength range different from the first wavelength range, and the third optical characteristic comprises a third wavelength range different from the first wavelength range and the second wavelength range.

13. The waveguide of claim 12, wherein the first structure comprises a first dichroic mirror, and the second structure comprises a second dichroic mirror.

14. The waveguide of claim 13, wherein the first dichroic mirror comprises a shortpass dichroic mirror with a cutoff wavelength between the first wavelength range and the second wavelength range and the second dichroic mirror comprises a second shortpass dichroic mirror with a cutoff wavelength between the third wavelength range and the first and second wavelength ranges.

15. The waveguide of claim 11, wherein the third incoupler is arranged subsequent to the first incoupler and the second incoupler in a direction of light propagation toward one or more outcouplers of the waveguide.

16. A method comprising:
incoupling, via a first incoupler, light with a first optical characteristic into a waveguide;
incoupling, via a second incoupler, light with a second optical characteristic into the waveguide; and
reflecting, by a first structure at an interface between the second incoupler and a waveguide substrate of the waveguide, incoupled light with the first optical characteristic within the waveguide.

17. The method of claim 16, wherein the first optical characteristic comprises a first wavelength range, and the second optical characteristic comprises a second wavelength range different from the first wavelength range, wherein the first structure comprises a first dichroic mirror with a cutoff wavelength between the first wavelength range and the second wavelength range.

18. The method of claim 17, further comprising:
incoupling, via a third incoupler, light with a third optical characteristic into the waveguide; and
reflecting, via a second structure at an interface between the third incoupler and the waveguide substrate of the waveguide, incoupled light with the first optical characteristic and incoupled light with the second optical characteristic within the waveguide.

19. The method of claim 18, wherein the third optical characteristic comprises a third wavelength range different from the first wavelength range and the second wavelength range, and the second structure comprises a second dichroic mirror with a cutoff wavelength between the third wavelength range and the first and second wavelength ranges.

20. The method of claim 16, wherein the first optical characteristic comprises a first polarization state, and the second optical characteristic comprises a second polarization state different from the first polarization state, and wherein the first structure comprises a polarization beam splitter.
